(19) United States
(12) Patent Application Publication
(10) Pub. No.: US 2007/0024922 A1
(43) Pub. Date: Feb. 1, 2007

(54) Image forming device and user terminal device to record printing information, and recording method thereof

(75) Inventor: Wan-joon Jeon, Seongnam-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/488,048

(22) Filed: Jul. 18, 2006

(30) Foreign Application Priority Data
Jul. 27, 2005 (KR) 2005-68491

(51) Int. Cl. H04N 1/387

(52) U.S. Cl. 358/453; 358/1.15

(57) ABSTRACT

An image forming device and a user terminal device to record printing information, and recording method thereof. The image forming device to record the printing information has a printing information extract part to extract printing information stored in Metadata of image data, a printing part to print the image data, and a control part to control the printing part to print the image data using the printing information and to store the printing information set at the time of the printing of the image data to the Metadata.

### CROSS-REFERENCE TO RELATED APPLICATIONS

This application claims priority under 35 U.S.C. § 119 (a) from Korean Patent Application No. 2005-68491, filed on Jul. 27, 2005, the entire content of which is incorporated herein by reference.

### BACKGROUND OF THE INVENTION

1. Field of the Invention

The present general inventive concept relates to an image forming device and a user terminal device to record printing information, and recording method thereof. More particularly, the present general inventive concept relates to an image forming device and a user terminal device to record printing information, which record the printing information to Metadata when printing an image data having the Metadata, and a recording method thereof.

2. Description of the Related Art

Generally, if trying to print printing data, such as image data, by using an image forming device, a user may operate function keys of an operation panel of the image forming device to set up a desired printer setting for the printing data.

To set up the desired printer setting, a user proceeds using various menus provided by the image forming device. Additionally, to move back to a previously used menu, the user should proceed using the same various menus.

To resolve the above disadvantages, an improved image forming device has been introduced, which memorizes a previously used menu and provides the memorized menu when a user tries to print using a menu that is the same as the previously used menu. Therefore, it is possible to easily move to the previously used menu by simple operations.

In other words, as a certain key is input by a user, the image forming device determines if the input key corresponds to a history key. If the input key does not corresponds to the history key, the image forming device normally controls the menu and stores to a history buffer the items changed by the menu control. If the input key corresponds to the history key, the image forming device searches the history buffer to provide the user with the corresponding stored menu.

A conventional method of using an image forming device to store a history key reads a pre-stored set value of a history buffer based on a user's selection and sets up a printer setting with the set value when printing, irrespective of kinds and features of corresponding printing data. Accordingly, as the printing data is output from the image forming device, it is impossible to know the printer setting at the time of printing the printing data. Additionally, due to a need for the history buffer, a dedicated area should be assigned in a memory for the history buffer.

### SUMMARY OF THE INVENTION

The present general inventive concept provides an image forming device and a user terminal device that assign a user preference area in Metadata of image data and store printing information at a time of printing printing data in the user preference area of the Metadata so as to efficiently perform printing, and a recording method thereof.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an image forming device to record printing information, including a printing information extract part to extract printing information stored in Metadata of image data, a printing part to print the image data, and a control part to control the printing part to print the image data by using the printing information and to store the printing information set at a time of the printing of the image data in the Metadata.

The Metadata may include an exchangeable image file format (EXIF) header including an EXIF area to store EXIF information and a user preference area to store user set-up printing information. The control part may store the user set-up printing information to the user preference area.

The device may further include a user interface part to receive the user set-up printing information from a user, and if the printing information is not extracted, the control part can control the printing part to print the image data in accordance with the user set-up printing information and can store the user set-up printing information to the Metadata.

The device may further include an image data input part to receive the image data from an exterior storage medium.

The exterior storage medium may be one of a user terminal device, a digital camera, a digital camcorder, and a memory card.

The device may further include a display part to display the extracted printing information. The control part may display the printing information extracted by the printing information extract part on the display part for the user's selection, and may control the printing part to print the image data in accordance with the user-selected printing information.

The display part may overlap the printing information on the image data.

The control part may control the printing part to print the extracted printing information.

If the printing information is extracted by the printing information extract part and the user set-up printing information is input through the user interface part, the control part may control the printing part to print the image data using the input user set-up printing information.

The foregoing and/or other aspects and utilities of the present general inventive concept may also be achieved by providing a user terminal device including a driver part to control a driving of an image forming device, the driver part including a printing information extract part to extract printing information of an image data, a user interface part to receive a user set-up printing information on the image data from a user, a driver control part to generate a printing control signal to print the image data in accordance with the extracted printing information, and to generate the printing control signal to print the image data in accordance with the user set-up printing information and to record the user set-up printing information in the user preference area if the printing information is not extracted, and an image forming device interface part to transmit a printing control signal generated by the driver part to the image forming device.

The foregoing and/or other aspects and utilities of the present general inventive concept may also be achieved by providing a method of recording printing information, including extracting the printing information stored in a Metadata of image data, printing the image data using the extracted printing information, and storing the printing information used in the printing of the image data to the Metadata.

The image data may be input by one of a user terminal device, a digital camera, a digital camcorder, and a memory card.

The Metadata may comprise an exchangeable image file format (EXIF) header including an EXIF area to store EXIF information and a user preference area to store user set-up printing information. The user set-up printing information may be stored to the user preference area.

The method may further include printing the extracted printing information.

The method may further include displaying the extracted printing information for a user's selection.

The printing of the image data may be performed in accordance with the selected printing information selected from the displayed printing information.

The printing of the image data may be performed in accordance with the input user set-up printing information if the printing information is extracted and the user set-up printing information is input.

The method may further include receiving the user set-up printing information from a user if the printing information is not extracted in the extracting the printing information, and recording the user set-up printing information to the Metadata and printing the image data in accordance with the user set-up printing information.

The foregoing and/or other aspects and utilities of the present general inventive concept may also be achieved by providing an apparatus to record printing information, including a memory unit to store image data to be printed, and a control part to generate second image data containing printing information when the image data is printed according to the printing information.

The foregoing and/or other aspects and utilities of the present general inventive concept may also be achieved by providing an apparatus to record printing information, including an input part to receive image data to be printed, and a control part to modify the image data to include printing information in an EXIF header of the image data when the image data is printed according to the printing information.

The foregoing and/or other aspects and utilities of the present general inventive concept may also be achieved by providing an apparatus to record printing information, including an input part to receive input image data, and a control part to store first image data having printing data and first printing information in the image data when the image data is printed according to the first printing information, and to store second image data having the printing data, the first printing information, and second printing information in the first image data when the first image data is printed according to the second printing information.

The foregoing and/or other aspects and utilities of the present general inventive concept may also be achieved by providing an apparatus to record printing information, including a storage part to store input image data having printing data and printing information, a control unit to modify the printing information, to store modified image data having the printing data, the printing information, and the modified printing information after the printing data has been printed as an image according to the modified printing information.

The foregoing and/or other aspects and utilities of the present general inventive concept may also be achieved by providing a computer readable recording medium including a computer readable code including a method of recording printing information, the method including extracting the printing information stored in Metadata of image data, printing the image data using the extracted printing information, and storing the printing information used in the printing of the image data to the Metadata.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating an EXIF header according to an embodiment of the present general inventive concept;

FIG. 2 is a block diagram illustrating an image forming device to record printing information according to an embodiment of the present general inventive concept;

FIG. 3 is a block diagram illustrating a user terminal device to record printing information according to an embodiment of the present general inventive concept;

FIG. 4 is a view illustrating a process of printing image data according to an embodiment of the present general inventive concept;

FIG. 5 is a view illustrating a process of printing image data according to another embodiment of the present general inventive concept; and

FIG. 6 is a flowchart illustrating a method of recording printing information according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

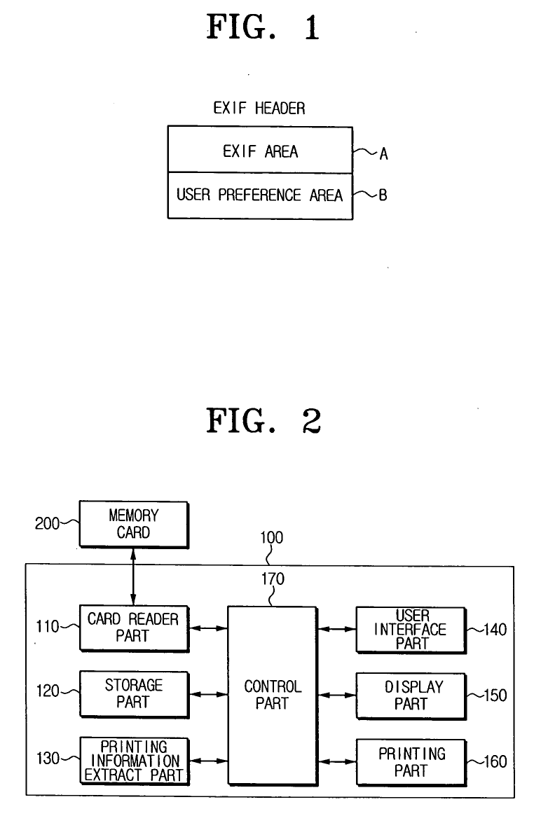

FIG. 1 is a view illustrating an exchangeable image file format (EXIF) header according to an embodiment of the present general inventive concept.

Image data can include a Metadata header containing information on the image data. The Metadata header may be the exchangeable image file format (EXIF) header that can store thereto certain data of a user's selection.

Examples of the image data including the EXIF header include, but are not limited to, a joint photographic experts group (JPEG) format image data, and a tag image file format (TIFF) image data. Generally, images photographed by a digital camera and a digital camcorder are stored in the JPEG format and include the EXIF header, and thus various embodiments of the present general inventive concept can be applied to the photographed images.

As illustrated in FIG. 1, the EXIF header of the image data according to the present embodiment can be divided into an EXIF area A to store existing EXIF information and a user preference area B to store printing information.

The EXIF area A can store printer setting information, such as a kind and a model name of a digital camera used to generate the image data.

The user preference area B can be assigned in the EXIF header separately from the EXIF area A, and can store printing information generated as the image data is printed. The printing information can be stored to the user preference area B, and because the user preference area B is assigned separately from the EXIF area A, the printing information of the image data is not influenced by the printer setting information stored in the EXIF area A, even when the printing information is several times recorded on the EXIF header. The printing information relates to, for example, printing settings and printing options.

FIG. 2 is a block diagram illustrating an image forming device 100 to record printing information according to an embodiment of the present general inventive concept.

Referring to FIG. 2, the image forming device 100 to record the printing information according to the present embodiment can include an image data input part (e.g., a card reader part 110), a storage part 120, a printing information extract part 130, a user interface part 140, a printing part 160, and a control part 170.

The image data input part can read at least one image data from an external storage medium. The exterior storage medium may be one of a user terminal device, a digital camera, a digital camcorder, and a memory card (e.g., a memory card 200). The external storage medium may be detachably attached to the image forming device 100.

In the present embodiment, the card reader part 110 can operate as the image data input part to read at least one image data of the memory card 200.

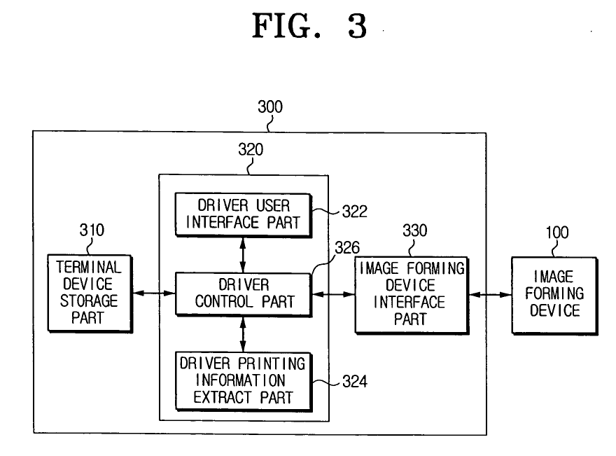

The storage part 120 can store the at least one image data transmitted from the image data input part, such as a user terminal device (300 of FIG. 3) or the memory card 200, and can provide the stored image data if the control part 170 requests the stored image data.

The printing information extract part 130 can extract the printing information from a user preference area of the image data (e.g., from the image data assigned to the user preference area B in the EXIF header of FIG. 1). The image data input to the printing information extract part 130 may be read from the memory card 200 through the card reader part 110, or from the storage part 120.

The user interface part 140 provides an interface between a user and the image forming device 100. The user interface part 140 receives user set-up printing information on the image data from a user and provides the control part 170 with the received user set-up printing information. The user set-up printing information relates to, for example, a printer setting and a printing option for the image data set by the user when the image data is printed.

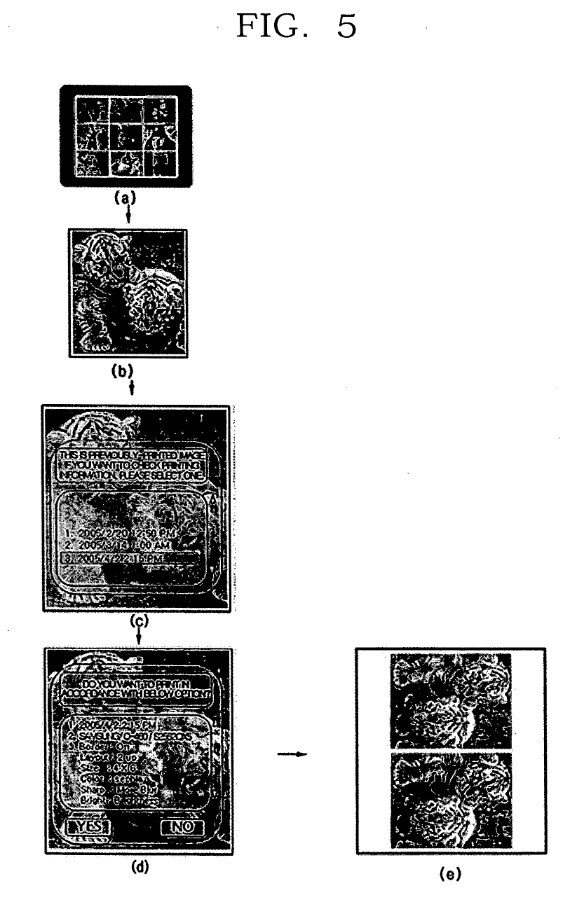

The image forming device 100 can also include a display part 150. The display part 150 displays information for the user to read under the control of the control part 170. The display part 150 may display at least one printing information extracted by the printing information extract part 130, and may allow the user to select at least one of the displayed printing information. Additionally, the display part 150 can display particulars of the selected printing information (see, for example, FIG. 5(d)) and the user can determine if the selected printing information is identical with the user set-up printing information.

The printing part 160 prints the printing data under the control of the control part 170. In the present embodiment, the printing data that can be printed by the printing part 160 is the image data, and the image data can be printed by applying one of the extracted printing information and the user set-up printing information. When the image data includes the printing data in the EXIF header, the printing data may be printed according to information of the EXIF header. The printing data may be called as the image data.

The control part 170 controls general operations of the image forming device 100. For example, the control part 170 controls input and output of signals among the card reader part 110, the storage part 120, the printing information extract part 130, the user interface part 140, the display part 150, and the printing part 160.

The control part 170 controls the card reader part 110 to read the image data, or can itself read the image data from the storage part 120. If a plurality of image data are read, the control part 170 displays the plurality of image data in thumbnail form on the display part 150 so that a user can select one or more image data from the plurality of image data.

If the printing information is extracted by the printing information extract part 130, the control part 170 controls the printing part 160 to print the image data using the extracted printing information. At this time, one or a plurality of printing information may be extracted by the printing information extract part 130. The control part 170 can control the display part 150 to display a list of the extracted printing information. A user can select one printing information from the list displayed on the display part 150, and the control part 170 controls the printing part 160 to print the image data in accordance with the selected printing information.

On the other hand, if the printing information is not extracted by the printing information extract part 130, the control part 170 receives the user set-up printing information through the user interface part 140, and controls the printing part 160 to print the image data in accordance with the input user set-up printing information. At this time, the control part 170 can store the user set-up printing information input by the user through the user interface part 140 to the user preference area of the EXIF header (e.g., the user preference area B of the EXIF header of the image data of FIG. 1).

If the printing information is extracted by the printing information extract part 130 and the user set-up printing information is also input by the user interface part 140, the control part 170 may control the printing part 160 to print the image data in accordance with the user set-up printing information.

FIG. 3 is a block diagram illustrating a user terminal device 300 to record printing information according to an embodiment of the present general inventive concept.

Referring to FIG. 3, the user terminal device 300 to record the printing information according to the present embodiment can include a terminal device storage part 310, a driver part 320, and an image forming device interface part 330 to connect the user terminal device 300 to an image forming device, such as the image forming device 100 of FIG. 2 or the image forming device 100 of FIG. 3.

The terminal device storage part 310 can store at least one image data and may provide the driver part 320 with the stored image data under the control of the driver part 320.

The driver part 320 can be a driver program to control the driving of the image forming device (e.g., the image forming device 100 of FIG. 3). The driver part 320 can include a driver user interface part 322, a driver printing information extract part 324, and a driver control part 326.

The driver user interface part 322 provides an interface between a user and the user terminal device 300. The driver user interface part 322 receives the user set-up printing information on the image data from the user and provides the driver control part 326 with the received user set-up printing information.

The driver printing information extract part 324 can extract the printing information from a user preference area of an EXIF header (e.g., the user preference area B of the image data of FIG. 1) and can have similar functions with the printing information extract part 130 of the image forming device 100 of FIG. 2. However, the printing information extracted by the driver printing information extract part 324 may be that stored in the terminal device storage part 310 of the user terminal device 300 (in addition to or as opposed to that stored in the image forming apparatus 100).

The driver control part 326 controls general functions of the driver part 320 to control the driving of the image forming device (e.g., the image forming device 100 of FIG. 3), and controls input and output of signals between, for example, the user interface part 322 and the driver printing information extract part 324.

The driver control part 326 can have similar functions with the control part 170 of the image forming device 100 of FIG. 2. In particular, the driver control part 326 generates printing control signals to print the image data in accordance with the extracted printing information or the user set-up printing information.

For example, if the printing information is extracted by the driver printing information extract part 324, the driver control part 326 can generate the printing control signals to print the image data in accordance with the extracted printing information.

On the other hand, if the printing information is not extracted by the driver printing information extract part 324, the driver control part 326 can receive the user set-up printing information through the driver user interface part 322, and generates the printing control signals to print the image data in accordance with the received user set-up printing information. The driver control part 326 stores the input user set-up printing information to a user preference area of the image data (e.g., the user preference area B of the EXIF header of the image data of FIG. 1).

If a plurality of printing information is extracted by the driver printing information extract part 324, the driver control part 326 provides the user with a list of the extracted printing information through the user interface part 322 so that the user can select one printing information from the plurality of printing information. If one printing information is selected, the driver control part 326 generates the printing control signals to print the image data in accordance with the selected printing information.

If the printing information is extracted by the driver printing information extract part 324 and the user set-up printing information is also input through the driver user interface part 322, the driver control part 326 may generate the printing control signal to print the image data in accordance with the user set-up printing information.

The image forming device interface part 330 provides an interface between the user terminal device 300 and the image forming device (e.g., the image forming device 100 of FIG. 3), and transmits the printing control signals generated by the driver control part 326 to the image forming device (such as the image forming device 100 of FIG. 3).

As illustrated in FIG. 3, the user terminal device 300 and the image forming device 100 can be connected to each other through the image forming device interface part 330. The image forming device 100 of FIG. 3 can be substantially the same as the image forming device 100 of FIG. 2. However, the user terminal device 300 of FIG. 3 performs at least some of the functions of the image forming device 100 of FIG. 2. Therefore, the image forming device 100 of FIG. 3 may not need to have all the functions or all the parts of the image forming device 100 of FIG. 2, but may still perform a general printing operation.

As described above, the image forming device 100 of FIG. 2 receives the image data from an external storage medium (such as the memory card 200, a user terminal device, a digital camera, or a digital camcorder) or the storage part 120. Thus, new printing information can be recorded in the user preference area of the image data (e.g., the user preference area B of the EXIF header of FIG. 1) in the image forming device 100 (e.g., in the storage part 120).

The user terminal device 300 of FIG. 3 receives the image data from the terminal device storage part 310 so that new printing information can be recorded in the user preference area of the image data (e.g., the user preference area B of the EXIF header of FIG. 1) of the user terminal device 300. However, if the image forming device 100 of FIG. 3 extracts the printing information with respect to the image data received from the user terminal device 300, new printing information cannot be recorded in the image forming device 100 of FIG. 3. Therefore, the printing information should be recorded in the user terminal device 300 having the image data. This will be explained below with reference to FIGS. 2 and 3.

The user terminal device 300 transmits the image data from the terminal device storage part 310 together with the printing command on the image data through the image forming device interface part 330 to the image forming device 100 of FIG. 3.

The image forming device 100 receives the image data through a terminal device interface part (not illustrated) from the user terminal device 300. The printing information extract part 130 extracts the printing information from the user preference area of the image data, and the control part 170 controls the printing part 160 to print the image data in accordance with the extracted printing information.

If no printing information is extracted by the printing information extract part 130, the control part 170 receives the user set-up printing information through the user interface part 140 and controls the printing part 160 to print the image data in accordance with the user set-up printing information.

When the image data is printed by the printing part 160, the control part 170 controls the terminal device interface part (not illustrated) to transmit the user set-up printing information to the terminal device 300 (as opposed to storing the user set-up printing information in the image forming apparatus 100). The terminal device 300 stores the user set-up printing information transmitted from the image forming device 100 to the user preference area of the EXIF header of the image data (e.g., in the terminal device storage part 310).

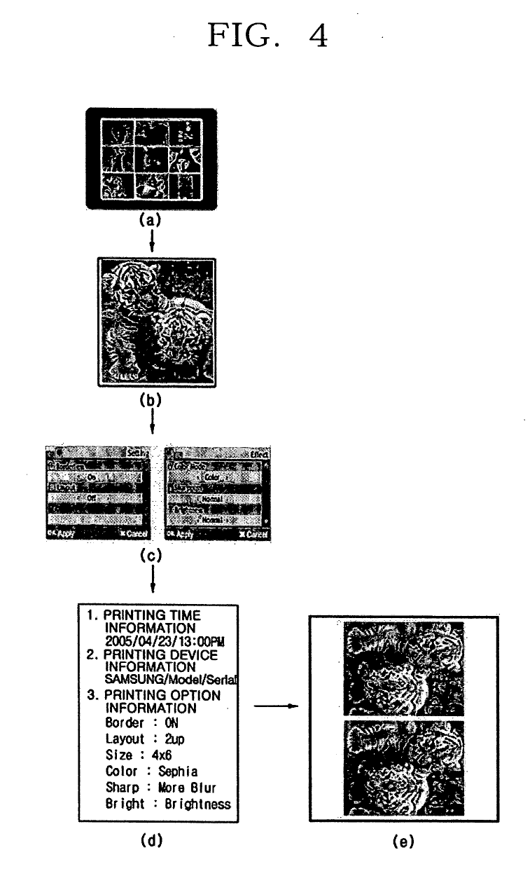

FIG. 4 is a view illustrating a process of printing image data according to an embodiment of the present general inventive concept.

The process of printing the image data, when no preset (prestored) printing information is in the image data that a user tries to print using an image forming device, will be explained below with reference to FIGS. 2 and 4.

Referring to operation (a) of FIG. 4, as the card reader part 110 reads a plurality of image data from an external storage medium (e.g., the memory card 200), the plurality of image data can be displayed in thumbnail form on the display part 150.

If a user selects one of the plurality of image data on the display part 150, the selected image data is enlarged and displayed as an original image data on the display part 150, as illustrated in operation (b) of FIG. 4.

Then, when one or more menus to set up the printing information for the selected image data is displayed on the display part 150, as illustrated in operation (c) of FIG. 4, a user can select desired printing settings and printing options of the printing information from the displayed menu. For example, as illustrated in operation (c) of FIG. 5, the user can select desired setting (left panel) and effect (right panel) settings/options to set up the printing information to print the image data.

When the printing information is set by the user, the set printing information is displayed, as illustrated in operation (d) of FIG. 4, so that the user can easily check the set printing information. Therefore, the user can determine if the printing information is correctly set. If printing is performed in accordance with the printing information, a desired print result can be obtained, as illustrated in operation operation (e) of FIG. 4.

FIG. 5 is a view illustrating a process of printing image data according to another embodiment of the present general inventive concept.

The process of printing the image data, when preset printing information is in the image data that a user tries to print by using the image forming device 100, will be explained below with reference to FIGS. 2 and 5.

A plurality of image data can be displayed in thumbnail form, as illustrated in operation (a) of FIG. 5. A user can then select one of the plurality of image data and the selected imaged data can be displayed, as illustrated in operation (b) of FIG. 5.

If the preset (pre-stored) printing information is extracted from the user preference area of the selected image data by the printing information extract part 130, a list of the printing information extracted by the printing information extract part 130 is displayed on the display part 150, as illustrated in operation (c) of FIG. 5. The list of the printing information may be overlapped on the image data, as illustrated in operation (b) of FIG. 5. However, the list can instead be displayed next to the image data or on a separate screen from the image data.

When a user selects one printing information from the list of the printing information, the printing settings and options of the selected printing information are displayed, as illustrated in operation (d) of FIG. 5. The printing settings and options of the selected printing information may be also overlapped on the image data. However, the printing information can instead be displayed next to the image data or on a separate screen from the image data.

As illustrated in operation (d) of FIG. 5, it is possible to ask the user if printing is to be performed in accordance with the displayed option, as illustrated in operation (d) of FIG. 5. The image data can then be printed in accordance with the displayed option to obtain the printing result, if the user chooses to do so. Alternatively, the user may choose not to use a stored printing information, and instead may choose to use new printing information different from the stored printing information. The new printing information can then be stored in the user preference area of the image data, as described above.

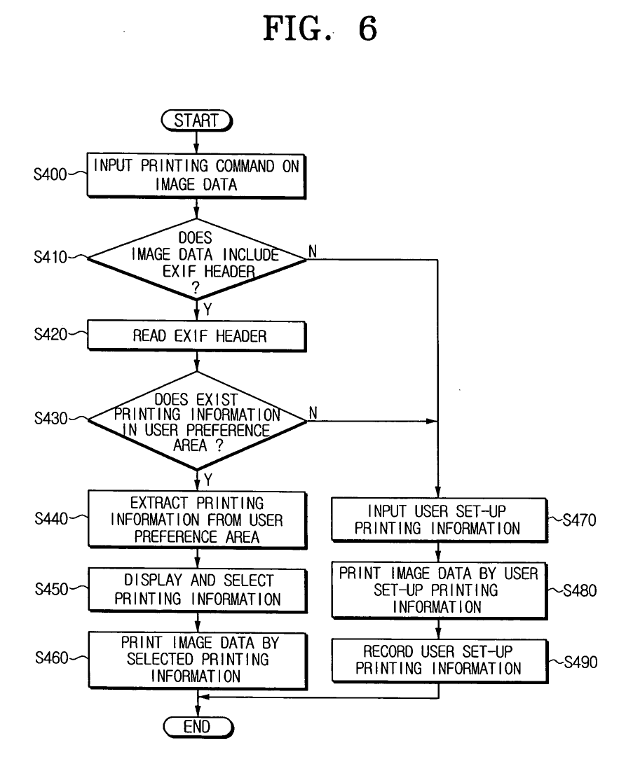

FIG. 6 is a flowchart illustrating a method of recording printing information according to an embodiment of the present general inventive concept.

The method of recording the printing information in a user preference area of image data (e.g., the user preference area B of the EXIF header of the image data of FIG. 1) by using the image forming device 100 as illustrated in FIG. 2 will be explained below with reference to FIGS. 2 and 6.

The image data is read from the memory card 200 by the card reader part 110, and a printing command is input on the read image data. In the embodiment illustrated in FIG. 6, the image data is one image data (operation S400). However, in embodiments the image data can be a plurality of image data.

When the printing command is input on the read image data, the control part 170 determines if the image data includes an EXIF header (operation S410).

If the image data includes the EXIF header (in operation S410), the control part 170 reads the EXIF header (operation S420). Additionally, the printing information extract part 130 reads the user preference area of the EXIF header to determine if there is pre-stored printing information in the user preference area of the EXIF header (operation S430).

If the pre-stored printing information is in the user preference area of the EXIF header (in operation S430), the printing information extract part 130 extracts the printing information from the user preference area of the EXIF header (operation S440).

If the printing information is extracted by the printing information extract part 130, the control part 170 controls the display part 150 to display a list of the extracted printing information. A user can then select one printing information to be applied to the image data from the printing information list displayed on the display part 150 (operation S450).

If the user selects a desired printing information, the control part 170 controls the printing part 160 to print the image data in accordance with the selected printing information. The printing part 160 applies the printing information controlled by the control part 170 to print the image data (operation S460).

If the image data does not include the EXIF header (in operation S410), or if there is no pre-stored printing information in the user preference area of the EXIF header (operation S430), the control part 170 receives user set-up printing information input by the user through the user interface part 140 (operation S470). The control part 170 then controls the printing part 160 to print image data in accordance with the input user set-up printing information. The printing part 160 applies the user set-up printing information to print the image data (operation S480).

When the printing of the image data is completed by the printing part 160, the control part 170 can record the user set-up printing information in the user preference area of the EXIF header of the image data (operation S490).

The user set-up printing information newly recorded in the user preference area of the EXIF header can be extracted together with pre-stored other printing information when the printing information extract part 130 extracts the pre-stored printing information stored in the user preference area of the EXIF header of the image data. For example, during subsequent printing operations, the newly recorded printing information will be displayed in the displayed list of printing information.

As described above, the image forming device 100 of FIG. 2 extracts the printing information from the image data of an external storage medium (such as the memory card 200) or the storage part 120, and the newly input user set-up printing information can be stored to the user preference area of the EXIF header of the image data. Therefore, it is possible to extract and record the printing information by using only the image forming device 100.

However, the present general inventive concept also encompasses the image forming device that receives the image data from the user terminal device 300, such as the image forming device 100 of FIG. 3. The image forming device 100 of FIG. 3 extracts the printing information of the image data transmitted from the user terminal device 300; however, the newly input user set-up printing information can be recorded to the user terminal device 300 but not to the image forming device 100. Therefore, the image forming device 100 of FIG. 3 transmits the input user set-up printing information to the user terminal device 300 so that the information can be recorded in the user preference area of the EXIF header of the image data in the user terminal device 300.

The driver part 320 of the user terminal device 300 of FIG. 3 extracts the printing information from the image data. The driver part 320 controls the driving of the image forming device 100 of FIG. 3. The newly input user set-up printing information can be stored to the user preference area of the EXIF header of the image data. Therefore, the user terminal device 300 having the image data extracts and records the printing information, and the image forming device 100 of FIG. 3 only prints the printing data transmitted from the user terminal device 300 in accordance with the printing control signals, without storing the printing information.

As described above, an image forming device and a user terminal device to record printing information, and a recording method thereof, according to various embodiments of the present general inventive concept assign a user preference area of an EXIF header of image data to record and store the printing information in the EXIF header of the image data. Therefore, as new printing information is additionally recorded it can be saved in a memory of the image forming device, a memory of the user terminal device, or an external memory.

Additionally, the printing information previously applied to the image data can be provided by simple operations. Therefore, steps of setting up menus to operate the image forming device using previously set printing information can be minimized, and the previously saved printing information can be accurately re-applied to the same image data.

Various embodiments of the present general inventive concept can be embodied as computer readable codes on a computer readable recording medium. The computer readable recording medium may include any data storage device suitable to store data that can thereafter be read by a computer system. Examples of the computer readable recording medium include, but are not limited to, a read-only memory (ROM), a random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Various embodiments of the present general inventive concept may also be embodied in hardware or in a combination of hardware and software.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming device to record printing information, comprising:
a printing information extract part to extract printing information stored in Metadata of image data;
a printing part to print the image data; and
a control part to control the printing part to print the image data using the printing information and to store the printing information set at a time of the printing of the image data in the Metadata.

2. The device as claimed in claim 1, wherein the Metadata comprises an EXIF header including an EXIF area to store EXIF information and a user preference area to store user set-up printing information.

3. The device as claimed in claim 2, wherein the control part stores the user set-up printing information to the user preference area.

4. The device as claimed in claim 1, further comprising:
a user interface part to receive user set-up printing information from a user,
wherein if the printing information is not extracted, the control part controls the printing part to print the image data in accordance with the user set-up printing information and to store the user set-up printing information to the Metadata.

5. The device as claimed in claim 1, further comprising:
an image data input part to receive the image data from an exterior storage medium.

6. The device as claimed in claim 5, wherein the exterior storage medium is one of a user terminal device, a digital camera, a digital camcorder, and a memory card.

7. The device as claimed in claim 1, further comprising:
a display part to display the extracted printing information.

8. The device as claimed in claim 7, wherein the control part displays the printing information extracted by the printing information extract part on the display part for a user's selection, and controls the printing part to print the image data in accordance with the user-selected printing information.

9. The device as claimed in claim 7, wherein the display part overlaps the printing information on the image data.

10. The device as claimed in claim 1, wherein the control part controls the printing part to print the extracted printing information.

11. The device as claimed in claim 1, wherein:
if the printing information is extracted by the printing information extract part and the user set-up printing information is input through the user interface part, the control part controls the printing part to print the image data using the input user set-up printing information.

12. A user terminal device useable with an image forming device, comprising:
a driver part to control a driving of an image forming device, the driver part comprising:
a printing information extract part to extract printing information of an image data,
a user interface part to receive user set-up printing information on the image data from a user, and
a driver control part to generate a printing control signal to print the image data in accordance with the extracted printing information if the printing information is extracted by the printing information extract part, and to generate the printing control signal to print the image data in accordance with the user set-up printing information and to record the user set-up printing information in the user preference area; and
an image forming device interface part to transmit a printing control signal generated by the driver part to the image forming device.

13. A method of recording printing information, comprising:
extracting the printing information stored in a Metadata of image data;
printing the image data using the extracted printing information; and
storing the printing information used in the printing of the image data to the Metadata.

14. The method as claimed in claim 13, wherein the image data is input by one of a user terminal device, a digital camera, a digital camcorder, and a memory card.

15. The method as claimed in claim 13, wherein the Metadata comprises an EXIF header including an EXIF area to store EXIF information and a user preference area to store user set-up printing information.

16. The method as claimed in claim 15, wherein the user set-up printing information is stored to the user preference area.

17. The method as claimed in claim 13, further comprising:
printing the extracted printing information.

18. The method as claimed in claim 13, further comprising:
displaying the extracted printing information for a user's selection.

19. The method as claimed in claim 18, wherein the printing of the image data is performed in accordance with the selected printing information selected from the displayed printing information.

20. The method as claimed in claim 13, wherein the printing of the image data is performed in accordance with input user set-up printing information if the printing information is extracted and the user set-up printing information is input.

21. The method as claimed in claim 13, further comprising:
receiving user set-up printing information from a user if the printing information is not extracted in the extracting the printing information; and
recording the user set-up printing information to the Metadata and printing the image data in accordance with the user set-up printing information.

22. An apparatus to record printing information, comprising:
an input part to receive input image data; and
a control part to store first image data having printing data and first printing information in the image data when the image data is printed according to the first printing information, and to store second image data having the printing data, the first printing information, and second printing information in the first image data when the first image data is printed according to the second printing information.

23. An apparatus to record printing information, comprising:
a storage part to store input image data having printing data and printing information;
a control unit to modify the printing information, to store modified image data having the printing data, the printing information, and the modified printing information after the printing data has been printed as an image according to the modified printing information.
